(19) United States
(12) Patent Application Publication
(10) Pub. No.: US 2009/0244670 A1
(43) Pub. Date: Oct. 1, 2009

(54) OPTICAL SCANNING APPARATUS

(75) Inventors: Kengo Sato, Kashiwa-shi (JP); Hiroshi Nakahata, Abiko-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/371,240

(22) Filed: Feb. 13, 2009

(30) Foreign Application Priority Data
Feb. 22, 2008 (JP) 2008-041455

(51) Int. Cl. G02B 26/08

(52) U.S. Cl. 359/205.1

(57) ABSTRACT

An optical scanning apparatus includes a light source for emitting light, a deflecting device including a deflecting element for deflection-scanning a surface to be scanned with the light emitted from the light source and including a motor for driving the deflecting element, and an optical system casing including a supporting surface for disposing thereon the deflecting device and including a wall provided to stand on the supporting surface and to face the deflecting element. At a portion at which the wall stands on the supporting surface, an opening is provided so as to extending along the wall.

### FIELD OF THE INVENTION AND RELATED ART

The present invention relates to an optical scanning apparatus (scanning optical apparatus) including a light source for emitting light, a deflecting device which includes a deflecting element for deflection-scanning a surface to be scanned with the light emitted from the light source and a motor for driving the deflecting element, and a supporting surface for supporting the light source and the deflecting device.

In the optical scanning apparatus used for an electrophotographic image forming apparatus, light flux (beam) emitted from the light source is subjected to optical modulation depending on an image signal. Then, the light flux subjected to optical modulation is periodically deflected by a polygonal mirror as rotating deflecting element and converges in a spot-like shape on a surface of an electrophotographic photosensitive member as an image bearing member having photosensitivity (hereinafter referred to as a “photosensitive drum”) by an imaging optical system having an fθ characteristic. At the spot on the imaging plane (surface), an electrostatic latent image is formed through main scanning with the polygonal mirror and sub-scanning by the rotation of the photosensitive drum, so that image recording is carried out.

When the polygonal mirror rotates, a driving portion such as a motor for driving the polygonal mirror generates heat. The heat is conducted to an imaging lens such as fθ lens, an optical element such as a folding mirror, and a casing in which the lens and the mirror are accommodated to cause thermal expansion (deformation) of the imaging lens, the optical element, and the casing. The slight deformation of these members causes an error in optical path of the light flux emitted from the light source. The error leads to a lowering in image quality.

In order to solve such a problem, a scanning optical apparatus provided with a shielding member between the polygonal mirror and the imaging lens so as to prevent the heat from being conducted to the imaging lens and the folding mirror has been disclosed. In this apparatus, a vertical wall having an opening for permitting passing of laser light is provided between the polygonal mirror and the optical lens. This vertical wall prevents heated air to reach the optical lens. Therefore, deformation of the optical lens by the heat is suppressed.

However, when the vertical wall is provided, the heated air reaches the vertical wall, so that the vertical wall is deformed.

In FIG. 24, a wall is provided in the neighborhood of a polygonal mirror. This wall 7a is provided integrally with an optical system casing. The wall 7a is provided with a laser passing opening 10a (10b) for permitting passing of laser light. As shown in FIG. 2, to an optical system casing, a cover for providing an enclosed inner structure is attached. The wall 7a does not contact the cover. By a supporting surface 6d, the polygonal mirror is supported. The polygonal mirror is not shown but is disposed in the neighborhood of the wall 7a so that a reflecting surface of the polygonal mirror faces the opening 10a (10b). When the polygonal mirror rotates, heated air reaches the wall 7a. Particularly, at the periphery of the opening 10a, a distance from the polygonal mirror is short, so that a temperature is high. As a result, an amount of deformation by thermal expansion at the periphery of the opening 10a is larger than that in an area apart from the opening 10a. For that reason, when rotation of the polygonal mirror starts and a temperature of the wall is increased, the wall is deformed toward the cover at the periphery of the opening 10a. Further, also in the area apart from the opening 10a, the wall is deformed toward the cover. However, the amount of deformation of the wall at the periphery of the opening 10a is larger than that in the area apart from the opening 10a, so that the optical system casing can be arched or bent as shown in FIG. 12. There is a possibility that the deformation of the optical system casing adversely affects all the optical elements accommodated in the optical system casing, so that a complicated optical path error more than that during deformation of a single optical element is caused to occur to result in a lowering in quality of an output image.

### SUMMARY OF THE INVENTION

In view of the above-described problem, the present invention has been accomplished. A principal object of the present invention is to provide an optical scanning apparatus having a constitution in which deformation of an optical system casing is less liable to occur even when a wall provided in the neighborhood of a polygonal mirror is deformed.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view of an image forming apparatus in Embodiment 1.

FIG. 2 is a partially enlarged view of FIG. 1.

FIG. 3 is a perspective view of an optical scanning apparatus in a state in which a covering member (a top cover) is removed to show an inside of an optical system casing.

FIG. 4 is a plan view of the optical scanning apparatus in a state in which the covering member is removed to show the inside of the optical system casing.

FIG. 5 is a perspective view of an outer appearance of a deflecting device.

FIG. 6 is a sub-scanning sectional view of a laser unit.

FIG. 7 is a development of an incident-side optical conversion system and an imaging optical system which include optical elements arranged from a single light source to a single surface to be scanned.

FIG. 8 is a partially enlarged view of a portion at which the deflecting device shown in FIG. 4 is disposed.

FIGS. 9A and 9B are enlarged sectional views taken along (9)-(9) line indicated in FIG. 8.

FIGS. 10(a) and 10(b) are schematic views each for illustrating flare light from one side of an opposing scanning system and a side wall for blocking the flare light.

FIG. 11 is a partially enlarged view of the optical system casing when the optical system casing is not provided with an opening at a bottom.

FIGS. 12A and 12B are a perspective view and a side view, respectively, showing a simulation result with respect to a state of deformation during temperature rise of the optical system casing shown in FIG. 11.

FIG. 13 is a schematic view for illustrating an opening provided at a bottom of the optical system casing.

FIG. 14 is a graph for illustrating an effect of providing the opening.

FIG. 15 is sectional view of the optical system casing when openings 9a and 9b are provided to a side wall 7a.

FIGS. 16, 17 and 18 are plan views each showing a shape and position of the opening provided at the bottom of the optical system casing in another embodiment.

FIG. 19 is a sectional view of a main structure portion of an optical scanning apparatus in Embodiment 3.

FIG. 20 is an enlarged perspective view of a portion at which a deflecting device is disposed.

FIG. 21 is a schematic view showing flow of the air in the optical scanning apparatus.

FIG. 22 is a graph for confirming an effect with respect to a change in color misregistration by an enclosed space portion constituted at a back surface of the optical system casing.

FIG. 23 is a plan view showing a shape and position of the opening provided at the bottom of the optical system casing as another embodiment.

FIG. 24 is a schematic view showing a conventional optical scanning apparatus including an optical system casing provided with no opening at a bottom.

### DESCRIPTION OF THE PREFERRED EMBODIMENTS

### Embodiment 1

### (1) Image Forming Apparatus

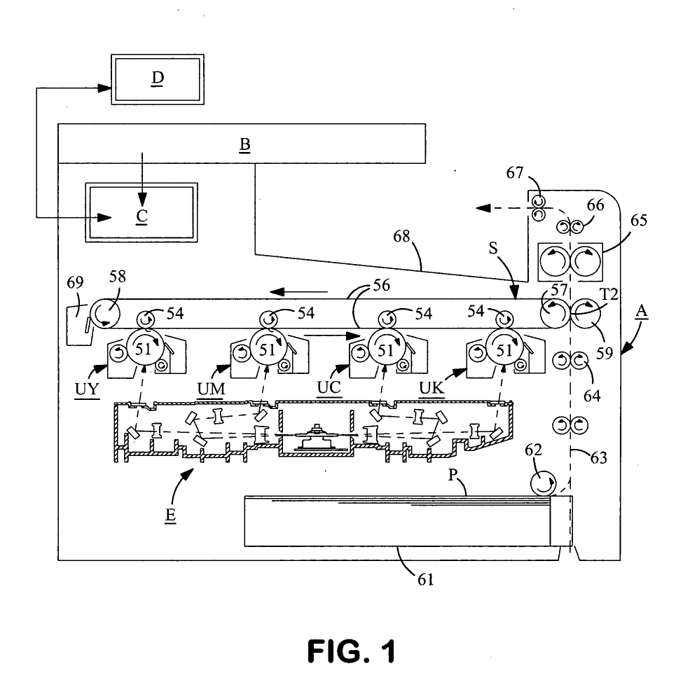

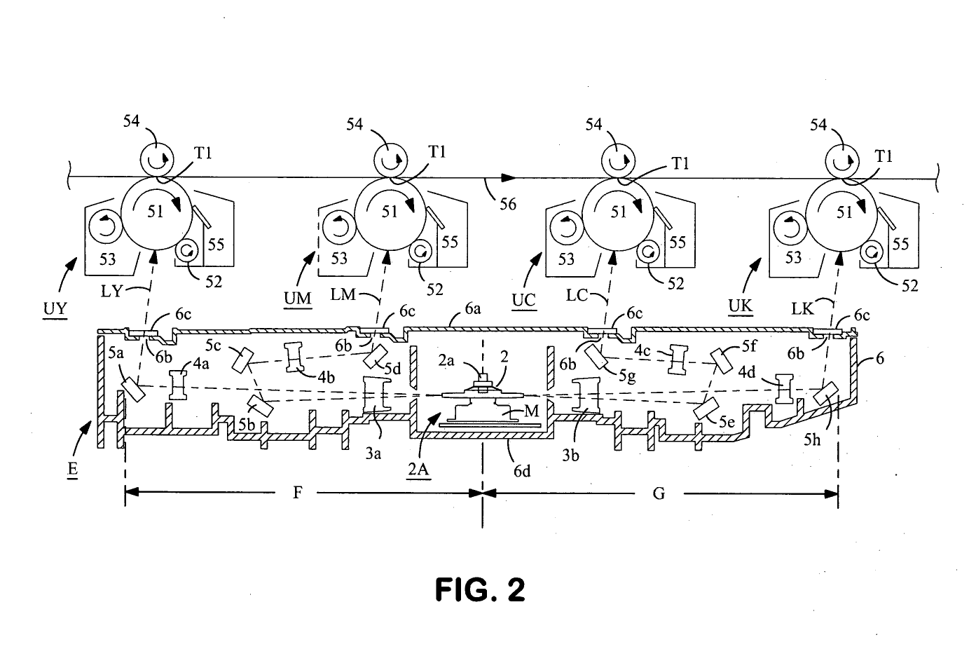

FIG. 1 is a schematic view showing an embodiment of an image forming apparatus in which an optical scanning apparatus (scanning optical apparatus) according to the present invention is mounted. FIG. 2 is a partially enlarged view of FIG. 1.

This image forming apparatus is tandem-type color image forming apparatus using electrophotography, a laser beam scanning exposure method, and an intermediary transfer belt method and is also a multi-function machine used as a copying machine, a printer, and a facsimile machine.

The image forming apparatus includes a printer station A and a reader station B mounted on the printer station A.

In the case of a copying machine mode, a photoelectric reading image signal (image information) of an original image is inputted from the reader station B into an image signal processing portion of a control circuit portion C. The image signal processing portion prepares digital image signals obtained by color-converting (separating) the inputted image signal into component image signals of yellow, magenta, cyan and black. Based on these image signals, the printer station A operates as the copying machine.

In the case of a printer mode, an image signal inputted from a personal computer or the like as an external device D into the image signal processing portion of the control circuit portion C is subjected to image processing and thus the printer station A operates as the printer.

In the case of a facsimile receiving mode, an image signal inputted from a remote facsimile machine as the external device D into the image signal processing portion of the control circuit portion C is subjected to image processing and thus the printer portion A operates as a facsimile receiving machine.

In the case of a facsimile sending (transmitting) mode, an original image signal photoelectrically read by the reader station B is inputted into the control circuit portion C and is sent to the remote facsimile machine as the external device D. Thus, the image forming apparatus operates as a facsimile sending machine.

The control circuit portion C is a control means (controller) for subjecting the image forming apparatus to centralized control in accordance with a predetermined program.

The printer station includes, as shown in FIG. 1, a plurality of image forming portions (stations) horizontally disposed in parallel to each other with a predetermined interval. In this embodiment, the image forming portions are first to fourth (four) image forming stations UY for forming a yellow (Y) tone image, UM for forming a magenta (M) toner image, UC for forming a cyan (C) toner image, and UK for forming a black (K) toner image, respectively.

The respective image forming stations are electrophotographic image forming mechanisms having the same constitution and at each of the image forming stations, a drum-type electrophotographic photosensitive member as an image bearing member (a member to be scanned or a recording medium) (hereinafter, referred to as a “photosensitive drum”) 51 is provided. The photosensitive drum 51 is rotationally driven in a clockwise direction indicated by an arrow at a predetermined speed. Around the photosensitive drum 51, image forming process means acting on the photosensitive drum 51 are provided. In this embodiment, the image forming process means are a primary charger 52, a developing device 53, a primary transfer roller 54, and a drum cleaning device 55. In the developing devices 53 of the first to fourth image forming stations, as developer, yellow (Y) toner, magenta (M) toner, cyan (C) toner, and black (K) toner are accommodated.

Below the first to fourth image forming stations UY, UM, UC and UK, an optical scanning apparatus E as an image exposure means is provided. The optical scanning apparatus E includes a light source for emitting light, a deflecting device including a deflecting element for deflection-scanning a surface to be scanned with the light emitted from the light source and a motor for driving the deflecting element, and an optical system casing for accommodating the light source and the deflecting device. The optical scanning apparatus E will be described more specifically in (2) appearing hereinbelow.

At the first image forming station UY, a surface of the photosensitive drum 51 which is rotationally driven and then is electrically charged by the primary charger 52 is irradiated with laser light flux (beam) LY, emitted as scanning light from the optical scanning apparatus E, modulated correspondingly to an image signal of a Y color component image for a full-color image. Thus, an electrostatic latent image is formed by the laser light flux LY. The latent image is developed as the Y toner image by the developing device 53.

At the second image forming station UM, a surface of the photosensitive drum 51 which is rotationally driven and then is electrically charged by the primary charger 52 is irradiated with laser light flux (beam) LM, emitted as scanning light from the optical scanning apparatus E, modulated correspondingly to an image signal of a M color component image for a full-color image. Thus, an electrostatic latent image is formed by the laser light flux LM. The latent image is developed as the M toner image by the developing device 53.

At the third image forming station UC, a surface of the photosensitive drum 51 which is rotationally driven and then is electrically charged by the primary charger 52 is irradiated with laser light flux (beam) LC, emitted as scanning light from the optical scanning apparatus E, modulated correspondingly to an image signal of a C color component image for a full-color image. Thus, an electrostatic latent image is formed by the laser light flux LC. The latent image is developed as the C toner image by the developing device 53.

At the fourth image forming station UK, a surface of the photosensitive drum 51 which is rotationally driven and then is electrically charged by the primary charger 52 is irradiated with laser light flux (beam) LK, emitted as scanning light from the optical scanning apparatus E, modulated correspondingly to an image signal of a K color component image for a full-color image. Thus, an electrostatic latent image is formed by the laser light flux LK. The latent image is developed as the K toner image by the developing device 53.

On the first to fourth image forming stations UY, YM, UC and UK, an endless intermediary transfer belt 56 is disposed. The belt 56 is stretched between belt conveying rollers 57 and 58 and is rotationally driven in a counterclockwise direction at a speed corresponding to the rotational speed of the photosensitive drum 51.

With respect to a lower surface of a lower belt portion of the belt 56, an upper position of the photosensitive drum 54 of each of the image forming stations faces. Each of the primary transfer rollers 65 is disposed inside the belt 56 and interposes the lower belt portion between it and the upper position of an associated photosensitive drum 54 in contact with each other. Contact portions between the belt 56 and the respective photosensitive drums 54 constitute primary transfer nips T1.

The belt conveying roller 57 interposes the belt 56 between it and a secondary transfer roller 59 in contact with each other. A contact portion between the belt 56 and the secondary transfer roller 59 constitutes a secondary transfer nip T2.

The control circuit portion C controls the respective image forming station UY, UM, UC and UK so as to perform an image forming operation on the basis of an image formation start signal and the color-separated component image signal for the inputted color image. As a result, at the image forming stations UY, UM, UC and UK, the color toner images of yellow, magenta, cyan and black are formed, respectively, on associated rotating photosensitive drums 51 with predetermined control timing. Electrophotographic image forming principle and process for forming the toner images on the photosensitive drums 51 are well known, thus being omitted from the description.

The above-described color toner images formed on the surfaces of the photosensitive drums 51 of the image forming stations are successively transferred onto the rotating belt 56 at the respective primary transfer nips T1 in a superposition manner. During the primary transfer, to each of the primary transfer rollers 54, a predetermined transfer bias is applied. As a result, on the surface of the belt 56, an unfixed full-color toner image is formed by the superposition of the four color toner images Y, M, C and K.

The drum cleaning device 55 of each of the image forming stations removes primary transfer residual toner remaining on the photosensitive drum 51 after the primary transfer of the toner images onto the belt 56.

The control circuit portion C drives a sheet-feeding roller 62 with predetermined sheet-feeding timing. As a result, one sheet of a recording material P is separated and fed from a sheet-feeding cassette 61 in which sheet-like recording materials (transfer paper) P are stacked and accommodated and then is conveyed to a registration roller pair 64 through a vertical conveying path 63.

At that time, rotation of the registration roller pair 64 is stopped and a leading edge of the recording material P is received by a nip of the registration roller pair 64, so that correction of oblique movement of the recording material P is carried out. Then, the registration roller pair 64 conveys the recording material P with timing so that the leading edge of the recording material P reaches the nip T2 in synchronism with arrival of a leading end of the full-color toner image formed on the rotation belt at the nip T2. As a result, at the secondary transfer nip T2, the component toner images of the full-color toner image are simultaneously secondary-transferred from the belt 56 onto the surface of the recording material P. During the secondary transfer, a predetermined transfer bias is applied to the secondary transfer roller 59.

The recording material P coming out of the secondary transfer nip T2 is separated from the surface of the belt 56 and introduced into a fixing device 65. By the fixing device 65, the above-described plurality of the color toner images is melted and mixed under heating and pressure, thus being fixed on the surface of the recording material P as a fixed image. The recording material coming out of the fixing device 65 is discharged as a full-color image formation product onto a sheet discharge tray 68 through a conveying roller pair 66 and a sheet discharging roller pair 67.

Secondary transfer residual toner remaining on the belt 56 is removed by a belt cleaning device 69 disposed outside the belt 56 so as to face the belt conveying roller 58 through the belt 56.

As a color deviation amount detecting means, a registration detection sensor (hereinafter referred to as a “registration sensor”) S is provided. This registration sensor S detects an amount of color misregistration by detecting a registration correction pattern for each color formed on the belt 56 and is fed back to the control circuit portion C. The control circuit portion C corrects the color misregistration due to a top margin and a side margin, based on the detection of the amount of the color misregistration by the registration sensor S, by electrically correcting writing timing of image data. Further, also with respect to color misregistration attributable to magnification, coincidence of the magnification is realized by minutely changing an image clock frequency.

### (2) Optical Scanning Apparatus E

In the following description, a main scan direction customarily refers to a longitudinal drum direction in which a scanning optical system of the optical scanning apparatus E optically scans the photosensitive drum surface as a surface to be scanned (i.e., a photosensitive drum axial direction or a photosensitive drum generatrix direction) or a direction corresponding to this direction. A sub-scan direction refers to a direction perpendicular to the longitudinal drum direction (the main scan direction) or a direction corresponding to this direction. FIGS. 1 and 2 show cross-sections with respect to the sub-scan direction.

The optical scanning apparatus E is a laser scanner and includes an optical system casing (box-like casing) 6 in which various optical elements (optical members) for constituting the scanner are accommodated. The various optical elements include a laser unit, an incident-side optical system, a deflecting device as a deflection scanning means, an emission-side optical system, a synchronization detecting element for determining writing timing of light flux (beam), and the like, as described later specifically. These various optical elements are held in the optical system casing at predetermined positions and with a predetermined arrangement by fixing means such as connection by screws, spring urging, and adhesive bonding. An upper surface of the optical system casing 6 is an open surface (an opened portion) and from the open surface, the above-described various optical elements are incorporated into the optical system casing 6. The open surface is covered with a covering member (top cover) 6a to be sealed (enclosed). The covering member 6a are provided with slit windows 6b through which the light fluxes LY, LM, LC and LK are emitted toward the photosensitive drums of the above-described first to fourth image forming stations, respectively. Each of the slit windows 6b is provided with a dustproof gloss member 6c.

The optical system casing 6 and the covering member 6a and formed of, e.g., a synthetic resin material such as polyphenylene ether (PPE) or polystyrene (PS) reinforced in mixture with glass fiber and are molded parts prepared by metallic molding (ejection molded parts of the glass fiber-reinforced resin material).

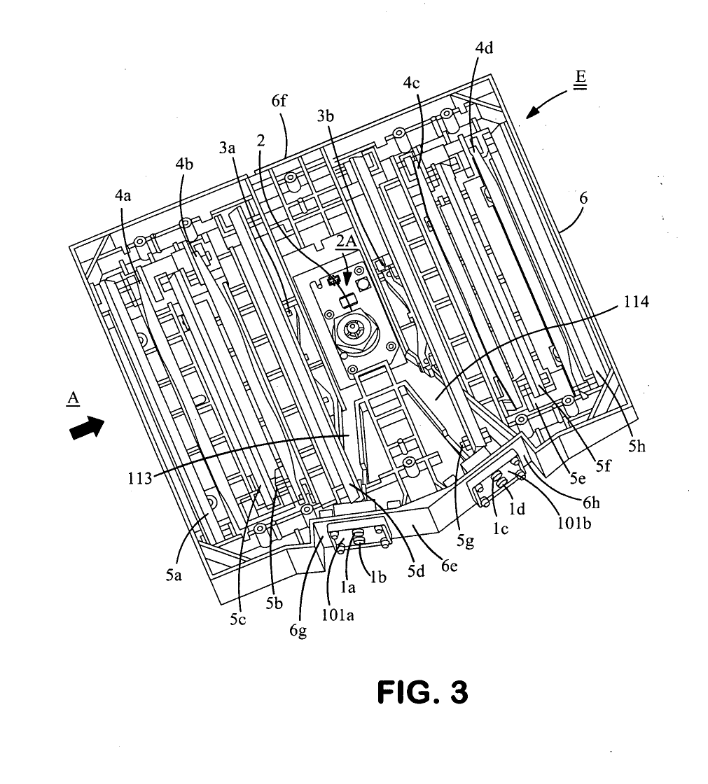

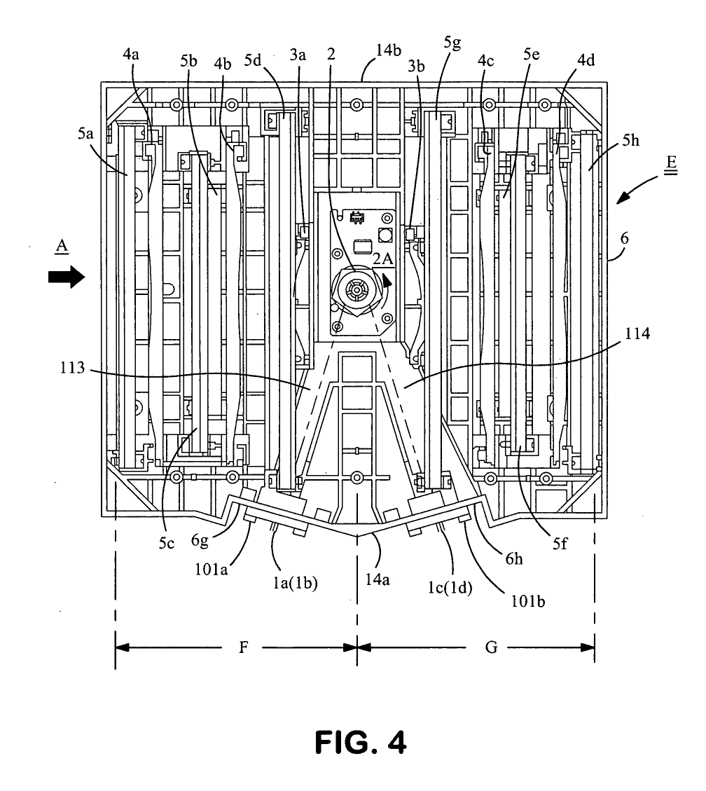

FIG. 3 is a perspective view of the optical system casing 6 from which the covering member 6a is removed to show the inside of the optical system casing 6, and FIG. 4 is a plan view of the optical system casing 6 from which the covering member 6a is removed to show the inside of the optical system casing 6.

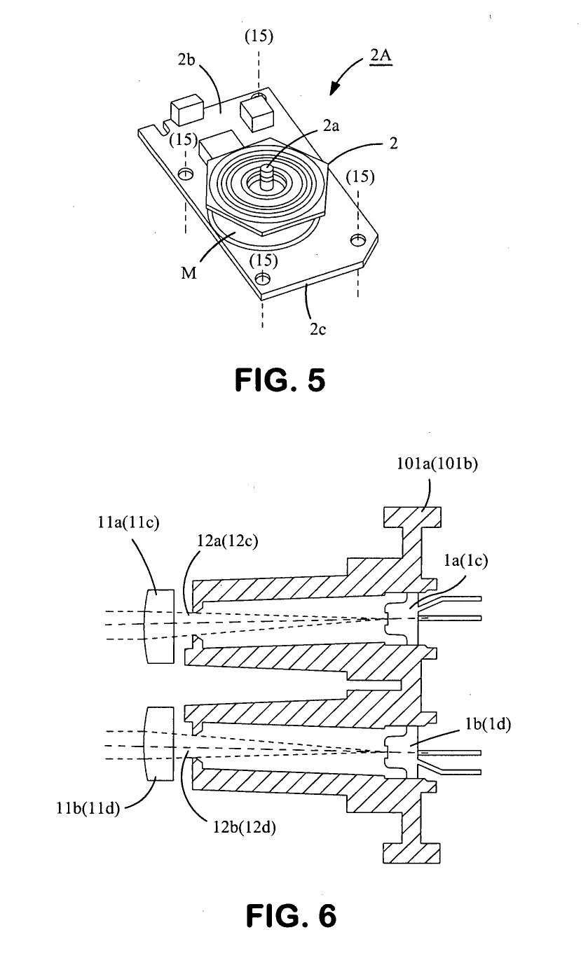

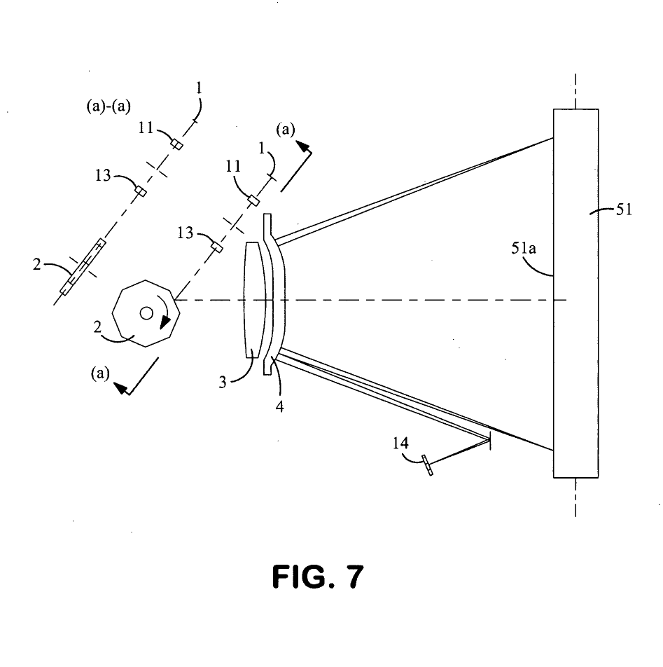

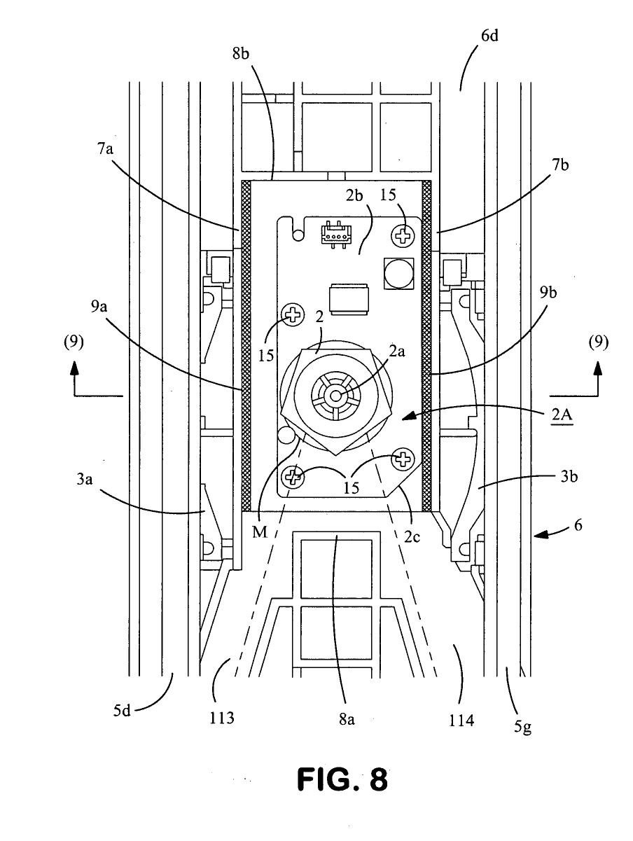

At a substantially central portion of the bottom of the optical system casing 6, a deflecting device 2A is disposed. FIG. 5 is a perspective view of an outer appearance of the deflecting device 2A alone. The deflecting device 2A includes a base plate (seat) 2c and a motor (polygonal mirror motor) M held on the base plate 2c. Further, the deflecting device 2A includes a polygonal mirror (rotatable polygonal mirror) 2, which is fixed to an upward rotation shaft 2a of the motor M, as a deflecting element for deflection-scanning a surface to be scanned with light emitted from a light source and includes a motor control circuit portion 2b which is provided on the base plate 2c and includes an integrated circuit (IC) and the like. The motor M is a driving means for driving the polygonal mirror 2 and, e.g., is a brushless DC motor. The deflecting device 2A is disposed, after the base plate 2c is positioned at a predetermined position of the substantially central portion at the bottom of the optical system casing 6, by being connected to a bottom plate 6d of the optical system casing 6 with screws 15 (FIG. 8).

The polygonal mirror 2 is rotated by the motor M in a counterclockwise direction indicated by an arrow in FIG. 4 at a high speed (generally in a range from about 20,000 rpm to about 40,000 rpm) in this embodiment.

The optical scanning apparatus E in this embodiment performs scanning exposure of a plurality of surfaces to be scanned (photosensitive drum surfaces at the first to fourth image forming stations) with a single polygonal mirror 2. For this purpose, on both sides of the polygonal mirror rotation shaft 2a (on a left-hand side and a right-hand side in FIGS. 2 and 4), first and second optical systems F and G each for forming an image of the light flux, on the surface to be scanned, used for the deflecting scanning by the polygonal mirror 2. Herein, the optical scanning apparatus of such a type is referred to as an “opposing type optical scanning apparatus” (an optical scanning apparatus having an opposing scanning system).

The first surface F and the second optical system G are bilateral (left-right) symmetrical optical systems. Each of the optical systems F and G includes the incident-side optical system (conversion optical system) and the emission-side optical system.

The incident-side optical system is an imaging optical system for forming an image of laser light (light flux), on the polygonal mirror 2, emitted from a semiconductor laser as the light source. This incident-side optical system is constituted by a compound lens having functions of a collimator lens (collimating lens) and a cylindrical lens for converging the laser light flux on the polygonal mirror in a long line shape with respect to the main scan direction.

The emission-side optical system is a scanning optical system for forming an image of the laser light, used for the deflection scanning by the polygonal mirror 2, on the photosensitive drum surface as the surface to be scanned and is constituted by a lens for performing fθ correction and a folding mirror.

A laser unit 101a for the first optical system F (a first laser unit) includes first and second (two) semiconductor lasers 1a and 1b as the light source for emitting the light (laser light). These first and second semiconductor lasers 1a and 1b are disposed with an appropriate interval with respect to a vertical direction.

A laser unit 101b for the first optical system G (a second laser unit) includes third and fourth (two) semiconductor lasers 1c and 1d as the light source for emitting the light (laser light). These third and fourth semiconductor lasers 1c and 1d are also disposed with an appropriate interval with respect to the vertical direction.

The first and second laser units 101a and 101b are fixed to light source fixing portions 6g and 6h, respectively, with predetermined angles. That is, the first and second laser units 101a and 101b have oblique incident angles with respect to Z direction and are disposed so that the respective laser light fluxes intersect with each other on a deflected surface of the polygonal mirror 2.

The first semiconductor laser 1a is a light source for the first image forming station UY and emits laser light modulated correspondingly to an image signal of a color-separated Y component image for the full-color image. The second semiconductor laser 1b is a light source for the second image forming station UM and emits laser light modulated correspondingly to an image signal of a color-separated M component image for the full-color image.

The third semiconductor laser 1c is a light source for the third image forming station UC and emits laser light modulated correspondingly to an image signal of a color-separated C component image for the full-color image. The fourth semiconductor laser 1d is a light source for the fourth image forming station UK and emits laser light modulated correspondingly to an image signal of a color-separated K component image for the full-color image.

FIG. 6 is a sub-scanning sectional view of the first laser unit 101a (or the second laser unit 10b). Collimator lenses 11a (11c) and 11b (11d) convert divergent light fluxes emitted from the semiconductor lasers 1a (1c) and 1b (1d) into substantially parallel light fluxes. Apertures (aperture stops) 12a (12c) and 12b (12d) shape the laser light fluxes emitted from the semiconductor lasers 1a (1c) and 1b (1d) into a desired optimum beam.

In this embodiment, the respective light fluxes optically modulated and emitted from the semiconductor lasers 1a (1c) and 1b (1d) are converted into the substantially parallel light fluxes. Then, the light fluxes are shaped into the desired beam. Thereafter, the light fluxes are incident on the cylindrical lens. Of the substantially parallel light fluxes having entered the cylindrical lens, those in the main scan cross section are emitted as they are. Further, those in the sub-scan cross section are converged to provide an image as a line image on a deflection surface of the polygonal mirror 2.

The above-described compound lens including the collimator lens and the cylindrical lens constitutes the incident-side optical system (conversion optical system) and causes the laser light (light flux) emitted from the semiconductor laser to provide an image on the polygonal mirror 2. The compound lens is adjusted and fixed at such a position that an irradiation position and a point of focus are ensured with respect to each of the laser light fluxes. The two laser light fluxes obliquely emitted from the first and second laser units 101a and 101b are converged with respect to the sub-scan direction by the above-described compound lens to form a line image at a single reflection point on the polygonal mirror 2 of the deflecting device 2A.

The light fluxes deflected and reflected at the deflection surface of the polygonal mirror 2 are converged to the photosensitive drum surface through associated emission-side optical systems for the light fluxes, so that the photosensitive drum surface is subjected to constant speed scanning with the light fluxes with respect to the main scan direction by rotation of the polygonal mirror 2. That is, the two laser light fluxes which are to be reflected by the reflection surface of the polygonal mirror and are to be subjected to the deflection scanning are obliquely reflected by the reflection surface with a vertically inverted relationship to travel toward imaging lenses 3a and 3b as fθ lenses of the emission-side optical systems.

FIG. 7 is a development of the incident-side optical system and the emission-side optical system which include optical elements from a single light source 1 to a single surface to be scanned 51a. The folding mirror is omitted. The light emitted from the light source 1 passes through a collimator lens 11 and is converted into a parallel light flux (beam). Thereafter, the light flux passes through a cylindrical lens 13 and once provides an image on a surface of the polygonal mirror 2. Then, the light flux deflected by the polygonal mirror 2 passes through a first imaging lens (fθ lens) 3 and a second imaging lens (fθlens) 4 and then provides an image at the surface 51a of the photosensitive drum 51 as a member to be scanned. By the first and second imaging lenses 3 and 4, fθ correction of the scanning light is performed. The image formation with respect to the sub-scan direction is principally performed by the second imaging lens 4. A reference numeral 14 represents a synchronism detecting element for determining writing timing of the light flux.

Specifically, laser scanning exposure with respect to the photosensitive drum surface at the first image forming station UY is carried out by the first optical system F along a path in the order of the first semiconductor laser 1a, the collimator lens 11, the cylindrical lens 13, a light guide path 113, the polygonal mirror 2, the first imaging lens 3a, the second imaging lens 4a, the folding mirror 5a, a slit window 6b, and a dustproof glass member 6c.

Laser scanning exposure with respect to the photosensitive drum surface at the second image forming station UM is carried out by the first optical system F along a path in the order of the second semiconductor laser 1b, the collimator lens 11, the cylindrical lens 13, a light guide path 113, the polygonal mirror 2, the folding mirror 5b, the folding mirror 5c, the second imaging lens 4b, the folding mirror 5d, a slit window 6b, and a dustproof glass member 6c.

Laser scanning exposure with respect to the photosensitive drum surface at the third image forming station UC is carried out by the second optical system G along a path in the order of the third semiconductor laser 1c, the collimator lens 11, the cylindrical lens 13, a light guide path 114, the polygonal mirror 2, the folding mirror 5e, the folding mirror 5f, the second imaging lens 4c, the folding mirror 5g, a slit window 6b, and a dustproof glass member 6c.

Laser scanning exposure with respect to the photosensitive drum surface at the fourth image forming station UK is carried out by the second optical system G along a path in the order of the fourth semiconductor laser 1d, the collimator lens 11, the cylindrical lens 13, a light guide path 114, the polygonal mirror 2, the first imaging lens 3b, the second imaging lens 4d, the folding mirror 5h, a slit window 6b, and a dustproof glass member 6c.

In the above paths, the first and second imaging lenses 3a, 3b, 4a and 4b are an fθ lens system. The second imaging lenses 4a and 4b are located closer to the surface to be scanned them the first imaging lenses 3a and 3b.

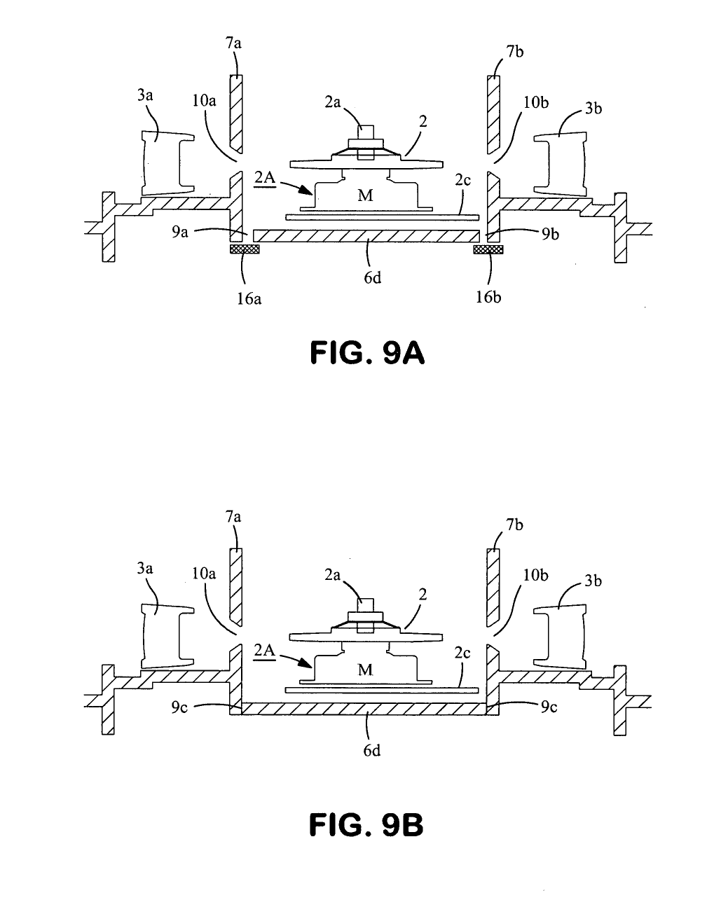

FIG. 8 is an enlarged plan view showing a portion at which the deflecting device 2A is disposed. FIGS. 9A and 9B are enlarged sectional views taken along (9)-(9) line indicated in FIG. 8.

In the optical system casing 6, ribs 7a, 7b, 8a and 8b are disposed on an optical system casing bottom plate 6d, located at the bottom of the optical system casing 6 and outside an area in which the deflecting device 2A is projected onto the bottom of the optical system casing 6 (surface of projection), so as to face the polygonal mirror 2. That is, the ribs 7a, 7b, 8a and 8b are provided on a supporting surface for supporting the deflecting device 2A so as to face the polygonal mirror 2 as the deflecting element. These ribs 7a, 7b, 8a and 8b are projection ribs which have a function of ensuring rigidity of the entire optical system casing 6 and intersect with the bottom of the optical system casing 6 (hereinafter referred to as “side wall(s)”.

The side wall 7a is located at a position between the polygonal mirror 2 and the first imaging lens 3a on the first optical system F side. The side wall 7b is located at a position between the polygonal mirror 2 and the first imaging lens 3b on the second optical system G side. These side walls 7a and 7b are provided with openings (frame-shaped portions) 10a and 10b. The light fluxes deflected and reflected by the polygonal mirror 2 pass through these openings 10a and 10b to enter the first optical system F and the second optical system G. That is, only the light fluxes having passed through these openings 10a and 10b can reach the photosensitive drum surfaces.

Further, openings 9a and 9b passing through the optical system casing bottom plate 6d are provided at the bottom of the optical system casing 6 and in the neighborhood of the side walls 7a and 7b. In FIGS. 8, 9A and 9B, the openings 9a and 9b are provided between the polygonal mirror 2 and the side wall 7a and between the polygonal mirror 2 and the side wall 7b, respectively, in an elongated slit shape having a substantially rectilinear configuration along the side walls 7a and 7b and are disposed in the neighborhood of base portions of the side walls 7a and 7b and substantially in parallel to the side walls 7a and 7b.

Further, to the openings 9a and 9b, flexible dust-proof members (sealing members) 16 and 16b for stopping up the openings 9a and 9b so as to prevent inclusion of dust such as dirt or fuzz from the outside to the inside of the optical system casing 6. The dustproof members 16a and 16b are, e.g., a seal member having flexibility.

The side walls 7a, 7b, 8a and 8b has the function as the rubs for ensuring the rigidity of the entire optical system casing as described above and also has a function of preventing flare light from reaching the photosensitive drum surface (a function as a flare preventing wall) as another function. Particularly, the side walls 7a and 7b prevent the flare light from one side of the opposing scanning system from reaching the photosensitive drum surface on the other side of the opposing scanning system.

The openings 9a and 9b described above have a function of suppressing deformation of the entire optical system casing in the case where an ambient temperature change with time occurs.

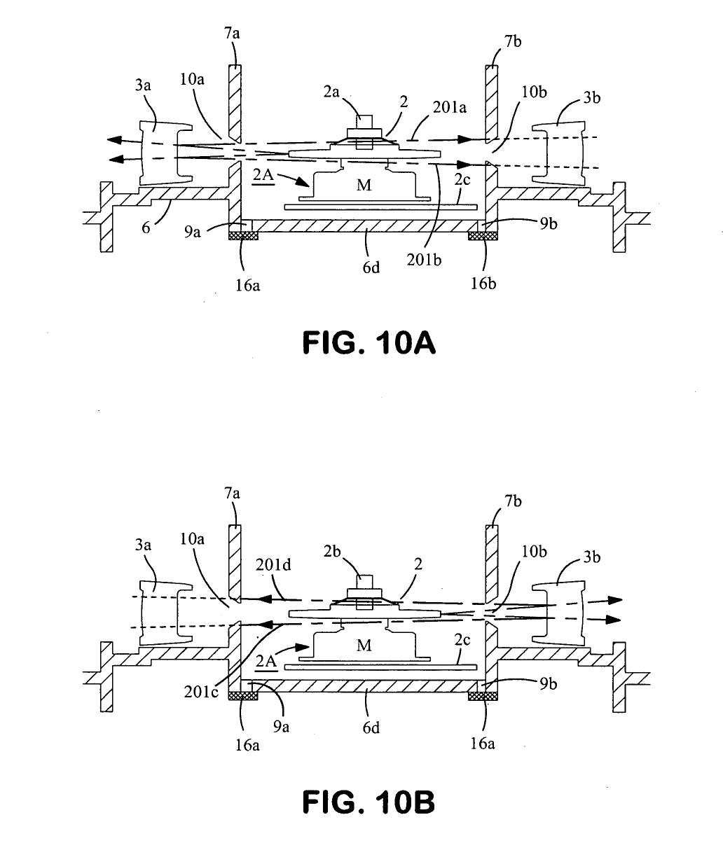

With reference to FIGS. 10(a) and 10(b), the above-described flare light from one side to the other side of the opposing scanning system and the side walls for preventing the flare light will be described.

As described above, in the first and second optical systems F and G, the light fluxes which are incident on the polygonal mirror 2 from the incident-side optical system and are deflected and reflected by the deflection surface of the polygonal mirror 2 reach the photosensitive drum surfaces at the first to fourth image forming stations UY, UM, UC and UK through the emission-side optical systems.

However, part of the light fluxes entering the first imaging lens 3a of the emission-side optical system on the first optical system F side and the second imaging lens 3b of the emission-side optical system on the second optical system G side is reflected at interfaces (surfaces) of the imaging lenses 3a and 3b and then is returned toward the polygonal mirror 2 side to provide light fluxes 201a to 201d.

These reflected light fluxes 201a to 201d, returned toward the polygonal mirror 2 side, as the part of the light fluxes entering the first and second imaging lenses 3a and 3b enter again an opposing imaging lens 3a or 3b which is disposed opposite to the other imaging lens 3b or 3a through the polygonal mirror 2. These light fluxes can reach the photosensitive drum surfaces which are different from those to be originally subjected to light exposure. There is also a possibility that the light fluxes 201a to 201d reach positions, different from exposure positions originally determined based on associated image information, after being reflected by the polygonal mirror 2 again or travel along other paths.

Herein, a light flux traveling along a path different from original path of the light fluxes used for the scanning exposure is referred to as the “flare light”.

When the flare light reaches the photosensitive drum surface, a defective image such that toner deposits on a position different from that for original image information occurs.

In this embodiment, by providing the side walls 7a, 7b, 8a and 8b, the rigidity of the optical system casing 6 can be ensured and it is also possible to prevent the above-described flare light. Particularly, by providing the side walls 7a and 7b, it is possible to prevent the flare light from an opposing side of the opposing scanning system with reliability.

However, there is an adverse effect due to provision of the side walls 7a, 7b, 8a and 8b in the neighborhood of the polygonal mirror 2. That is, when the side walls 7a, 7b, 8a and 8b are located in the neighborhood of the polygonal mirror 2, heat generation of the deflecting device 2A by rotational drive of the polygonal mirror 2 rapidly increases temperatures of the side walls 7a, 7b, 8a and 8b by convection heat transfer by the rotation of the polygonal mirror 2. As a result, the side walls 7a, 7b, 8a and 8b increased in temperature thermally expand locally, thus causing torsional deformation of the entire optical system casing.

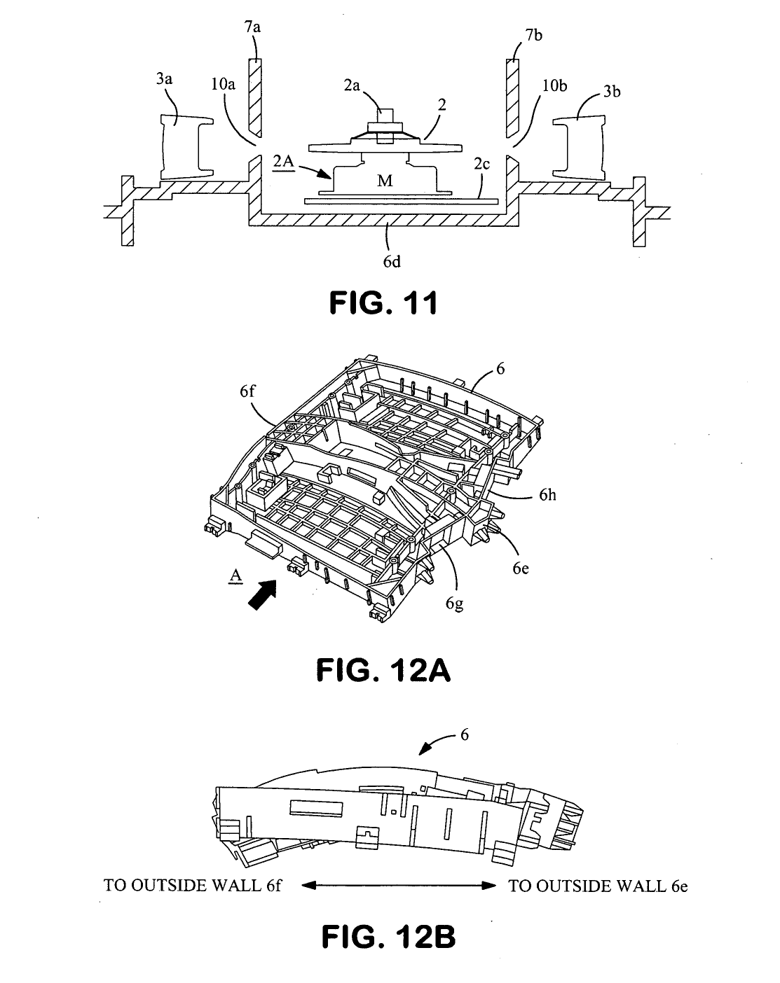

With reference to FIGS. 11, 12A and 12B, the deformation of the optical system casing 6 and irradiation position fluctuation due to the temperature rise of the optical scanning apparatus will be described.

In the optical scanning apparatus E, when the polygonal mirror 2 is subjected to rotation control for image formation, the optical elements accommodated in the optical system casing 6 are warmed by heat generation of the motor M of the deflecting device 2A or the motor control substrate 2b such as the IC or the like.

When a temperature change with time occurs, the optical system casing 6 or the optical elements are deformed, so that an optical path error occurs and thus a change in irradiation position or in inclination or bending is caused to occur. Particularly, in the case where an optical system casing formed of plastics is used, compared with the case of using an optical system casing formed of metal such as Al, a linear expansion coefficient is large and a thermal conductivity is low. Therefore, an amount of deformation of the optical system casing is larger. Further, by complicated deformation, there is a variation in irradiation position change among the respective image forming stations, so that the variation leads to color misregistration and color unevenness, thus deteriorating an image quality.

When the polygonal mirror 2 is rotated at a predetermined speed, the temperatures of the side walls 7a and 7b located at the periphery of the polygonal mirror 2 (the deflecting device 2A) are particularly increased quickly. The reason why the rise of temperature occurs abruptly is that the side walls 7a and 7b are quickly warmed due to the convection heat conduction by rotational airflow of the polygonal mirror 2. When part of the optical system casing 6 is quickly warmed by the convection heat conduction, a distribution of temperature occurs in the optical system casing 6, so that the optical system casing 6 is largely deformed. That is, as described above, the side walls 7a, 7b, 8a and 8b provided for ensuring the rigidity and preventing the flare light can cause the large deformation of the optical system casing 6 as the adverse effect.

FIG. 11 is a partially enlarged view of the optical system casing 6 when the optical system casing 6 is not provided with an opening at the bottom of the optical system casing 6. FIGS. 12A and 12B are schematic views showing a simulation result with respect to a state of deformation during the temperature rise of the optical system casing 6 when the optical system casing 6 is not provided with the opening at the bottom of the optical system casing 6 as shown in FIG. 11. FIG. 12A is a perspective view showing the deformation simulation result of the optical system casing 6 and FIG. 12B is a side view (as seen in a direction of an arrow A shown in FIGS. 12A, 3 and 4) showing the deformation simulation result of the optical system casing 6. FIGS. 12A and 12B are exaggerated views of the optical system casing 6 in which a degree of deformation is exaggerated so as to be understood easily.

The simulation result is a result such that thermo-fluid analysis and thermal deformation analysis are performed through the simulation based on actually measured values of an amount of temperature rise during operations of the optical scanning apparatus (during turning on of the laser and during drive of the polygonal mirror motor). The analyses are performed by using a personal computer and an analysis software used is a simulation software using a general finite element method.

As shown in the simulation results of FIGS. 12A and 12B, the optical system casing 6 is upwardly convexly deformed when the optical system casing 6 is increased in temperature due to the heat generation by the rotation of the polygonal mirror 2. As a result, outer walls 6e and 6f of the optical system casing 6 are deformed toward the outside of the optical system casing 6. At this time, the laser units 101a and 101b mounted on the outer wall 6e and also deformed outwardly by the deformation of the outer wall 6e of the optical system casing 6. When the laser units 101a and 101b are deformed, an optical axis of the light incident on the polygonal mirror 2 is inclined, so that changes in irradiation position and bending are caused to occur. Particularly, a sensitivity to an amount of the change in irradiation position with respect to the deformation of the laser units 101a and 101b is larger than that with respect to deformation of other optical elements. When the deformation of the optical system casing 6 is complicated, variation of the amount of change in irradiation position at each of the image forming stations occurs, thus causing image failure such as color misregistration or color unevenness.

In the opposing scanning type apparatus such as the optical scanning apparatus E in this embodiment, in the case where the laser units 101a and 101b are provided on the same side, i.e., on the outer wall 6e, each of the laser units 101a and 101b is deformed with respect to the same direction during the temperature rise. At this time, the irradiation positions of the image forming stations disposed oppositely to each other through the polygonal mirror 2 are changed to opposite directions, so that particularly the color misregistration and the like are liable to be conspicuous and an image quality is liable to deteriorate.

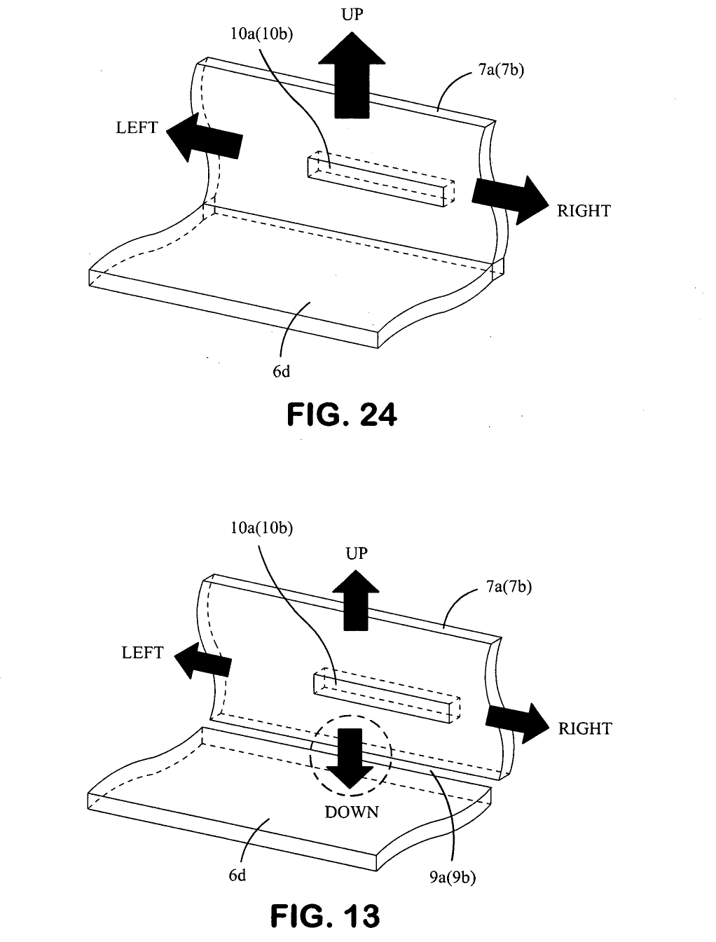

Next, an effect of the openings 9a and 9b provided to the bottom of the optical system casing 6 will be described with reference to FIGS. 13, 14 and 23.

FIG. 23 is a schematic view showing an optical scanning apparatus in which no opening is provided at the bottom where the polygonal mirror 2 is to be mounted. FIG. 13 is a schematic view of an optical scanning apparatus in which the openings 9a and 9b are provided at the bottom. In the optical scanning apparatus shown in FIG. 23, when the side wall 7a (7b) is thermally expanded by the influence of heat generation by rotational drive of the polygonal mirror 2, the bottom having high rigidity is less liable to relieve the deformation. For this reason, a degree of deformation with respect to upward and horizontal directions in which the deformation is liable to occur. As a result, the entire optical system casing 6 is deformed so as to provide a convex shape (FIGS. 12A and 12B).

On the other hand, in the optical scanning apparatus having a constitution shown in FIG. 13, the opening 9a (9b) as shown in FIGS. 8 and 9 is provided in the neighborhood of a base portion of the wall 7 a(7b), so that it is possible to relieve deformation shown in FIG. 24 when the side wall 7a (7b) is thermally expanded due to the heat generation by the rotational drive of the polygonal mirror 2. That is, the side wall 7a (7b) is deformable also with respect to a downward direction, so that a force exerted on the optical system casing during deformation is distributed. As a result, the convex deformation of the entire optical system casing 6 is relieved.

By such a constitution, it is possible to prevent the occurrences of the irradiation position change, the scanning line inclination, bending, and the like at the surface to be scanned.

In order to adjust a scanning line forming position, there is a correction method in which a toner image for detecting misregistration occurring among respective colors on the photosensitive drums and light emission timing is controlled on the basis of an amount of the detected misregistration (auto-registration correction). This auto-registration correction is made every time a predetermined number of image formation is carried out. The toner image for detecting the color misregistration is formed and therefore the image formation can be carried out during a period in which the toner image is formed. However, by employing the above-described constitution, it is possible to suppress a frequency of the adjustment such as the auto-registration correction or the like, at a minimum level, performed for detecting the scanning line forming position. For this reason, it is possible to prevent a lowering in productivity.

Further, by using such an optical scanning apparatus, even when a change in ambient temperature occurs in an image forming apparatus for carrying out color printing or the like, it is possible to easily obtain a good image with less color unevenness or color misregistration. Thus, it is possible to compatibly expedite downsizing and higher performance.

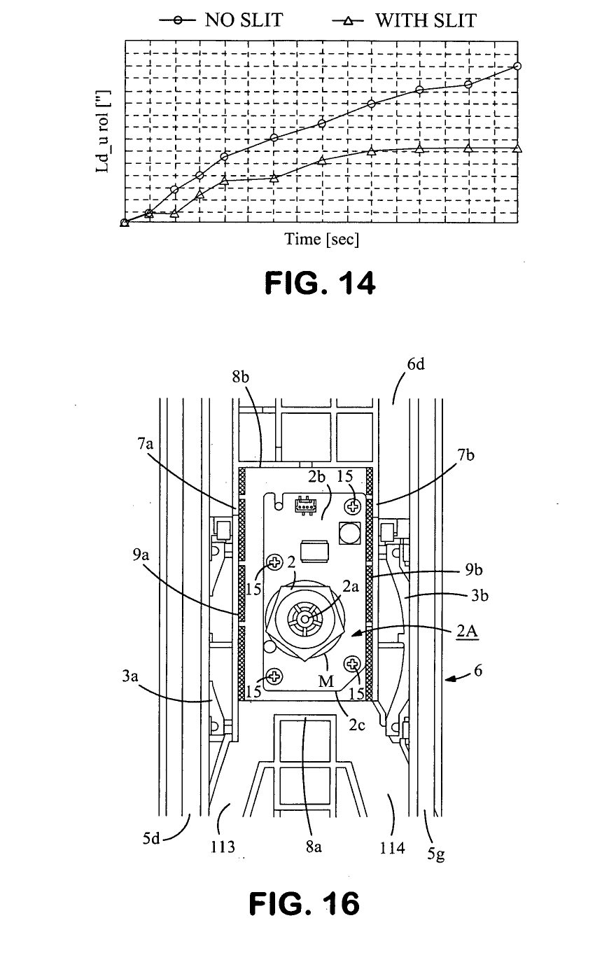

FIG. 14 is a graph showing actually measured values of an amount of deformation of the entire optical system casing, when the bottom of the optical system casing 6 is provided with the openings (slits) 9a and 9b and when the bottom of the optical system casing 6 is not provided with the openings (slits), in terms of a converted amount of deformation of the laser units 101a and 101b mounted on the outer wall of the optical system casing 6. FIG. 14 is a graph showing the amount of deformation of the laser units 101a and 101b when the polygonal mirror 2 is rotationally driven for a certain time at an ambient circumstance of 25° C. An ordinate represents the amount of deformation of the laser unit 101a (10b) in terms of a deformation angle (″) (sec). An abscissa represents an elapsed time (sec) from start of the operations of the optical scanning apparatus (turning on the laser and drive of the polygonal mirror). The deformation amount of the laser unit 101a (10b) is substantially equivalent to that of the side wall on which the laser unit 101a (10b) is mounted.

A measuring method of the deformation amount shown in FIG. 14 is as follows. A degree of inclination (deformation) of the laser unit during the operations of the optical scanning apparatus (turning on the laser and drive of the polygonal mirror is measured by using an angular displacement meter (measuring device). In this embodiment, a mirror is attached to the laser unit and an amount of angular displacement is measured by an autocollimator, the principle of which is omitted from the description.

As shown in FIG. 14, the deformation amount of the laser unit 101a (10b) when the bottom of the optical system casing 6 is provided with the opening 9a (9b) is reduced by about half when compared with the case when the bottom of the optical system casing 6 is not provided with the opening 9a (9b).

In this embodiment, the reason why the openings 9a and 9b are provided along the side walls 7a and 7b at the bottom of the optical system casing 6 includes the following two factors 1) and 2):

1) that rise in temperature of the wall closest to the polygonal mirror 2 is quick, and

2) that a direction of deformation of the side wall 7a (7b) is the same as a direction affecting the deformation of the laser unit 101a (10b) having a high sensitivity to the irradiation position change.

In the case where the openings 9a and 9b are applied to another optical scanning apparatus, positions corresponding to the positions described in this embodiment are not always optimum. The optimum positions vary depending on parameters such as a shape and temperature distribution of the optical system casing, a direction in which the deformation of the optical system casing is not desired, and an amount of a change in ambient temperature.

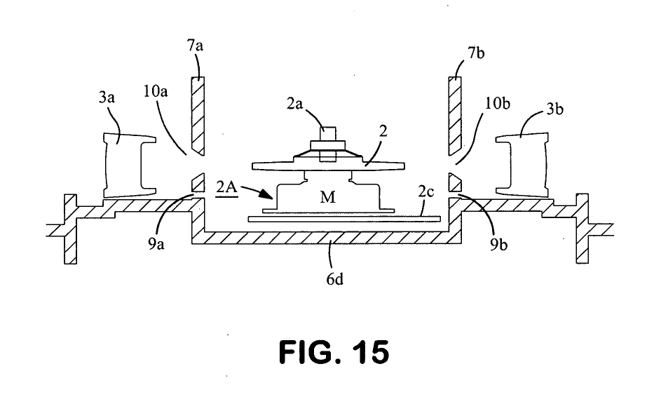

In this embodiment, the openings 9a and 9b are provided at the bottom of the optical system casing 6. As another embodiment, as shown in FIG. 15A, the openings 9a and 9b may also be provided to the side walls 7a and 7b. By providing the openings 9a and 9b at lower portions of the openings 10a and 10b for passing of the laser light, it is possible to reduce the deformation amount of the optical system casing 6 even when the side walls 7a and 7b are thermally expanded.

Further, as shown in FIG. 9B, cuts 9c may be provided at the bottom in the neighborhood of the base portions of the side walls 7a and 7b. In FIG. 9B, the surface on the side wall 7a side and the surface of the bottom are separated from each other. That is, both of the surfaces contact each other and are relatively movable. For that reason, in the case where the side wall 7a is deformed, only the side wall 7a is downwardly deformed, so that the bottom is less liable to be deformed.

### Embodiment 2

FIGS. 16 to 18 are plan views each showing a shape and position of the openings 9a and 9b provided at the bottom of the optical system casing 6 in another embodiment.

1) In FIG. 16, the openings 9a and 9b are provided at the bottom of the optical system casing 6 in the neighborhood of the side walls 7a and 7b. These openings 9a and 9b are provided in a shape of intermittent elongated slits (a dotted or broken line shape) between the polygonal mirror 2 and the side wall 7a and between the polygonal mirror 2 and the side wall 7b, respectively, and are disposed in the neighborhood of the base portions of the side walls and in substantially in parallel to and along the side walls.

2) In FIG. 17, the openings 9a and 9b are provided at the bottom of the optical system casing 6 in the neighborhood of the side walls 8a and 8b. These openings 9a and 9b are provided in a shape of an elongated slit (a substantially rectilinear shape) between the polygonal mirror 2 and the side wall 8a and between the polygonal mirror 2 and the side wall 8b, respectively, and are disposed in the neighborhood of the base portions of the side walls and in substantially in parallel to and along the side walls.

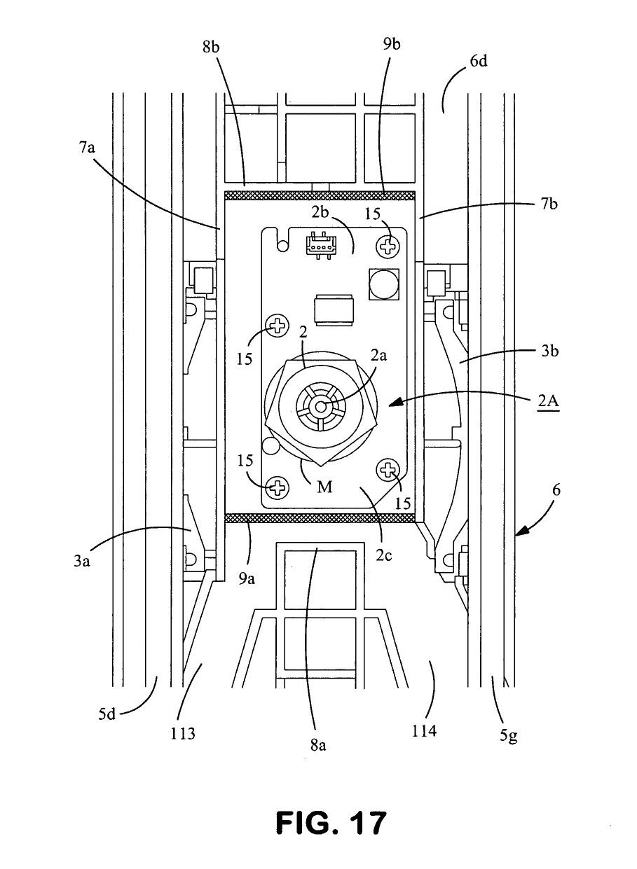

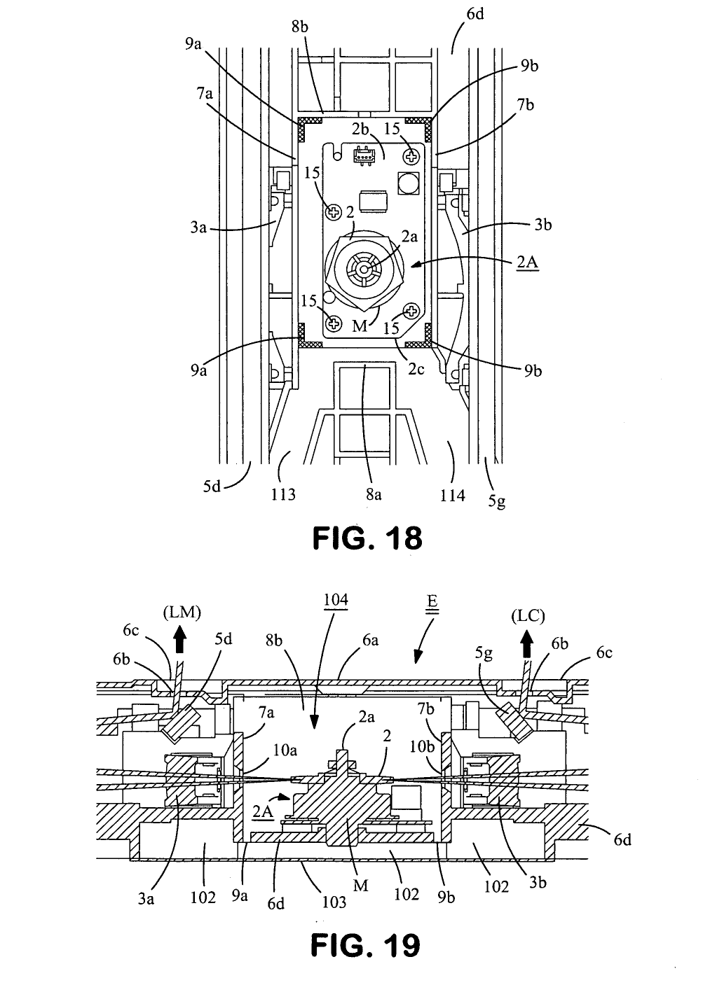

3) In FIG. 18, the openings 9a and 9b are provided at the bottom of the optical system casing 6 in the neighborhood of the side walls 7a and 7b and the side walls 8a and 8b. These openings 9a and 9b are provided in a nonlinear shape of elongated slits (L-shape) between the polygonal mirror 2 and associated side walls and are disposed in the neighborhood of the base portions of the side walls and in substantially in parallel to and along the side walls.

4) As described above, depending on the conditions such as the optical system casing shape and the temperature distribution of the optical system casing, optimum shape and position of the openings 9a and 9b may preferably be selected. Shapes and positions other than these shown in FIGS. 8, 9A, 9B, 16, 17 and 18 may also be selected.

For example, the openings 9a and 9b may also be provided on a side of an associated side wall opposite from a side of the associated side wall facing the polygonal mirror 2 and disposed in arrangements such that the openings 9a and 9b are provided in the neighborhood of a base portion of the side wall, in parallel to the side wall, along the side wall, in the rectilinear shape, in the nonlinear shape, in the dotted line shape, and the like.

Further, the openings 9a and 9b may be disposed in appropriate combinations of the various arrangements as described above.

Incidentally, it can also be considered that the openings 9a and 9b lower the rigidity of the optical system casing 6, so that the opening shape and the arrangement of the openings are required to be balanced with necessary rigidity of the optical system casing 6.

In this embodiment, in order to take a dustproof measure, such a constitution that the openings 9a and 9b provided at the bottom of the optical system casing 6 are covered with the dustproof members 16a and 16b is employed. However, such a constitution that the openings 9a and 9b are opened so as to actively dissipate heat by the rotational drive of the polygonal mirror 2 together with air flow through the openings 9a and 9b may also be employed. By employing these constitutes, it is possible to achieve a further temperature rise-preventing effect. Further, in view of a dust-proofness, such a constitution that a filterable member such as a dust filter is provided to the openings 9a and 9b to permit passing only of the air may also be employed.

The optical scanning apparatus E in this embodiment is the opposing scanning type apparatus including the above-described incident side optical system and emission side optical system with respect to each of both sides of the rotation shaft of the single deflecting element, in order to expose a plurality of surfaces to be scanned to light with the single deflecting element. The optical scanning apparatus of the present invention is not limited to the opposing scanning type apparatus but may also be an optical scanning apparatus including at least one of the incident side optical system and at least of the emission side optical system with respect to the single deflecting element.

The optical scanning apparatus E in this embodiment, even when it is of the opposing scanning type, can suppress occurrences of deterioration in aberration at an image surface by deviation of a light flux from an optical axis due to a change in ambient temperature at a minimum level with a simple constitution and thus can prevent an image quality.

As a result, it is also possible to suppress a frequency of adjustment such as the auto-registration or the like with respect to the change in ambient temperature with time at a minimum level and thus to prevent a lowering in productivity.

Further, by using such an optical scanning apparatus, even in the case where the ambient temperature change occurs in an image forming apparatus for carrying out color printing or the like.

### Embodiment 3

FIGS. 19 to 23 are schematic views for illustrating this embodiment. Constituent members or portions common to the optical scanning apparatus E of Embodiment 1 and Embodiment 2 are represented by the same reference numerals or symbols, thus being omitted from redundant explanation.

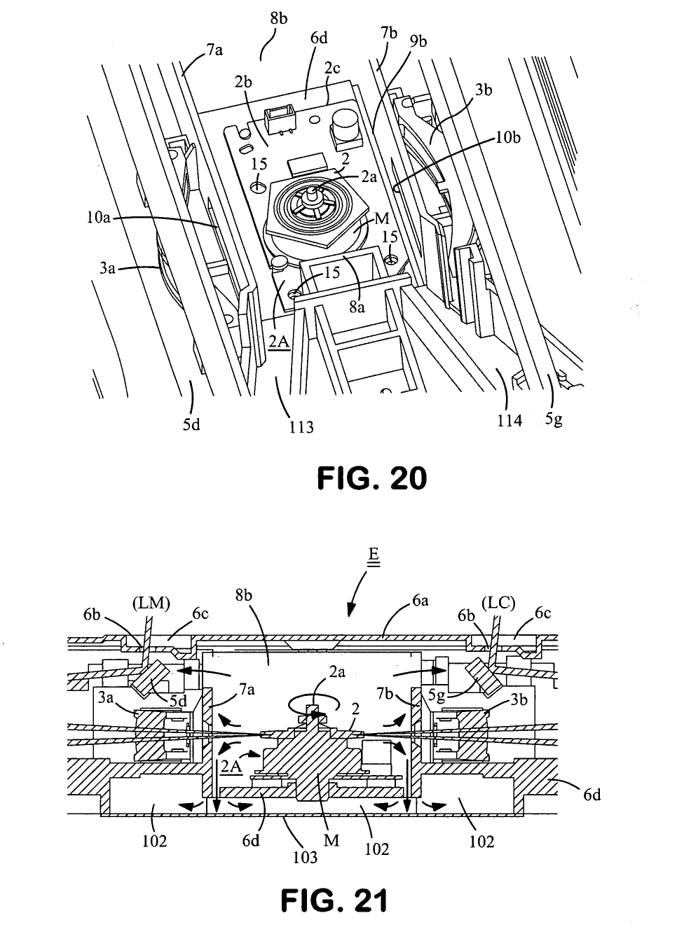

An optical scanning apparatus in this embodiment is, as shown in FIGS. 19 and 20, provided with the openings 9a and 9b to the optical system casing bottom plate 6d similarly as in Embodiments 1 and 2. The optical system casing includes a first chamber 104 as an accommodating portion in which the polygonal mirror 2 is accommodated. Further, the optical system casing includes an enclosed space portion (second chamber) 102 which is separated from the first chamber 104 by the optical system casing bottom plate 6d, as a supporting surface for supporting the polygonal mirror 2, and which is enclosed so as to be separated from the outside of the optical system casing. On the supporting surface 6d, ribs 7a and 7b provided to face the polygonal mirror 2 are formed. In the neighborhood of base portions of the ribs 7a and 7b on the supporting surface 6d, the openings 9a and 9b for establishing communication between the first chamber and the second chamber are provided. Outside the optical system casing bottom plate 6d, a shielding member 103 constitution the enclosed space portion 102, at which the openings 9a and 9b are opened, in combination with the optical system casing bottom plate 6d is provided. The shielding member 103 is provided at the bottom of the optical system casing.

That is, the optical system casing 6 includes the first chamber in which at least the deflecting device 2A is accommodated and the second chamber 102 which is separated from the first chamber by the deflecting device supporting surface and which is enclosed so as to be separated from the outside of the optical system casing. Further, the optical system casing includes the openings 9a and 9b establishing communication between the first chamber 104 and the second chamber 102 in the neighborhood of the ribs 7a and 7b facing the deflecting device 2A on the supporting surface.

The optical scanning apparatus in this embodiment employs, in order to improve an assembling property, such a constitution that respective optical parts (optical elements) such as the imaging lens, the polygonal mirror motor, and the folding mirror are assembled into the optical system casing 6 all from above the optical scanning apparatus E. For that reason, there is no optical part on the backside of the optical system casing.

The openings 9a and 9b are, as shown in FIG. 20, provided similarly as in the constitutions shown in FIG. 8 and FIGS. 9A and 9B. That is, these openings 9a and 9b are provided in a shape of an elongated slit (a substantially rectilinear shape) between the polygonal mirror 2 and the side wall 7a and between the polygonal mirror 2 and the side wall 7b, respectively, and are disposed in the neighborhood of the base portions of the side walls 7a and 7b and in substantially in parallel to and along the side walls 7a and 7b. This is because the stream of the air, flowing along the side walls 7a and 7b, generated by the rotation of the polygonal mirror 2 is liable to flow toward the backside of the optical system casing 6 (toward the outside of the optical system casing bottom plate 6d).

FIG. 21 is a schematic view showing the flow of the air in the optical scanning apparatus E by arrows. The air flow (stream) generated by the rotation of the polygonal mirror 2 through the drive of the polygonal mirror 2 strikes against wall surfaces of the side walls 7a and 7b provided to the optical system casing 6 as shown in the figure and then moves downwardly and passes through the openings 9a and 9b to reach the backside of the optical system casing 6 as it is. The heat of the air flow which has reached the backside of the optical system casing 6 warms the enclosed space portion 102 constituted outside the optical system casing bottom plate 6d. As a result, an amount of heat dissipated from a space between the optical system casing 6 and the covering member 6a into the optical system casing 6 is decreased. Correspondingly to the decrease in the amount of heat, an amount of heat provided to the optical parts assembled in the optical system casing 6 is decreased.

In the entire area of the openings 9a and 9b, the air is not always caused to flow toward the backside of the optical system casing 6 but by the air flowing toward the backside, part of the air present in the enclosed space portion 102 flows back into the optical system casing 6. However, this nearly means that the air present in the enclosed space portion 102 on the backside of the optical system casing 6 flows into the optical system casing 6. Therefore, an effect of retaining a moderate increase in temperature of the optical parts is ensured until a temperature difference between the inside and outside of the optical system casing bottom plate 6d is eliminated.

With a smaller volume of the enclosed space portion 102 constituted on the optical system casing backside, a thermal capacity of the enclosed space portion 102 is decreased in a larger amount. For this reason, it is clear that the enclosed space portion 102 ensured as large as possible is effective.

Further, when the shielding member 103 is constituted by a metallic member, particularly a metal-made member such as an aluminum material, the heat can be effectively dissipated to the outside of the optical scanning apparatus, so that it is possible to suppress a temperature rise amount per se of the optical scanning apparatus.

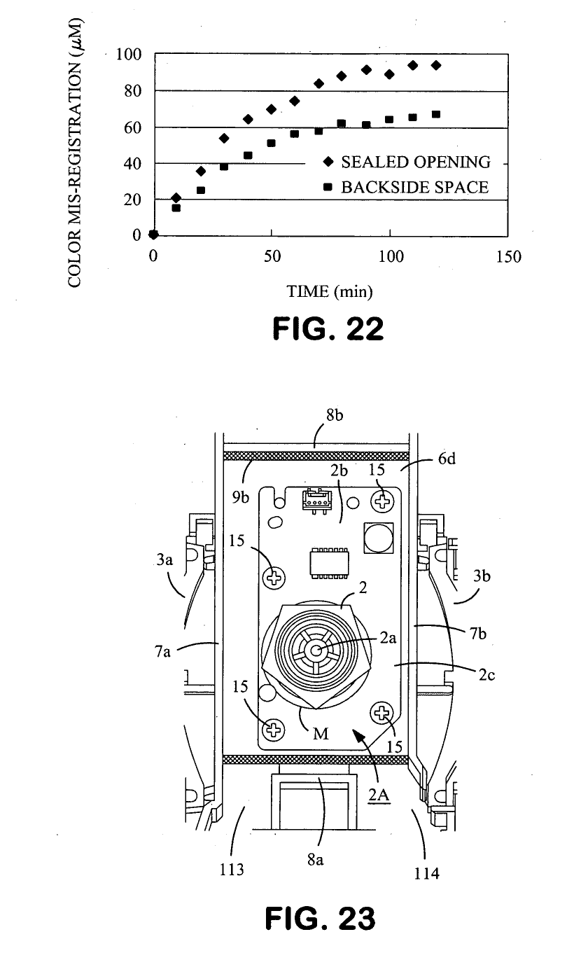

FIG. 22 is a graph for confirming an effect with respect to a change in color misregistration by the enclosed space portion constituted at the back surface of the optical system casing. In an experiment for this purpose, a changing rate and an amount of change are evaluated with respect to the following two constitutions 1) and 2):

1) Constitution in which the openings 9a and 9b are formed as shown in FIGS. 8, 9A and 9B and are sealed (covered) with the flexible sealing members 16a and 16b as the dustproof member on the backside of the openings 9a and 9b (“WITH SEALED OPENING”), and

2) Constitution in which the openings 9a and 9b are provided to the optical system casing bottom plate 6d as in this embodiment. Further, outside the optical system casing bottom plate 6d, the aluminum-made shielding member 103 constituting the enclosed space portion 102, at which the openings 9a and 9b are opened, in combination with the optical system casing bottom plate 6d (“WITH BACKSIDE SPACE”).

Data shown in FIG. 22 are measured data, as representative data, at an image center position with respect to the sub-scan direction. At other exposure positions, an amount of color misregistration is different from that shown in FIG. 22 due to the influence of inclination and bending but it is clear that a similar effect can be achieved.

The openings 9a and 9b are not required to be provided in a bilateral symmetry manner with respect to the polygonal mirror 2 as shown in FIG. 19. Further, the openings 9a and 9b are also not required to be disposed at two positions but either one of the openings 9a and 9b may be disposed at a single position. However, in the case of the opening disposed at the single position, an amount of the air flowing into the enclosed space portion 102 located on the backside of the optical system casing 6 is decreased, so that a color misregistration suppressing (alleviating) effect is lowered. Further, the openings 9a and 9b may be disposed at any position so long as they are constituted along the side walls located at the periphery of the polygonal mirror 2. For example, the openings 9a and 9b may be disposed, as shown in FIG. 23, with respect to a direction perpendicular to that for the openings 9a and 9b shown in FIG. 19. Further, a length of the openings 9a and 9b is not necessarily equal to an entire length of the side walls but may also be equal to part of the entire length.

In the above description, the optical scanning apparatus of the type wherein the plurality of photosensitive drums is exposed to light by using a single polygonal mirror motor (a single polygonal mirror) is used is described. However, in the present invention, even a method in which a plurality of optical scanning apparatuses is used for light exposure for the respective colors can suppress the temperature rise amount of each of the optical scanning apparatuses, thus achieving the same effect.

According to the constitution of this embodiment, it is possible to suppress or alleviate the changing rate and the amount of change of the color misregistration while satisfactorily retaining the assembling property of the optical scanning apparatus.

As described hereinabove, in the optical scanning apparatus to be mounted in the image forming apparatus including the plurality of photosensitive drums, such a constitution that the polygonal mirror motor, the folding mirror, the imaging lens, and the like are assembled into the optical system casing from the same direction is employed. At the periphery of the polygonal mirror, the openings formed toward a direction opposite from the photosensitive drums with respect to the optical scanning apparatus. Further, to the backside of these openings, the shielding member for shielding the entire optical scanning apparatus or part of the optical scanning apparatus is mounted, thus forming a space between the optical system casing and the shielding member. As a result, it is possible to suppress or alleviate the changing rate and the amount of change of the color misregistration while satisfactorily retaining the assembling property of the optical scanning apparatus.

The present invention may also be carried out in combination with the constitutions of the conventional optical scanning apparatus.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 041455/2008 filed Feb. 22, 2008, which is hereby incorporated by reference.

What is claimed is:

1. An optical scanning apparatus comprising:
a light source for emitting light;
a deflecting device including a deflecting element for deflection-scanning a surface to be scanned with the light emitted from said light source and including a motor for driving said deflecting element; and
an optical system casing including a supporting surface for supporting thereon said deflecting device and including a wall provided to stand on the supporting surface and to face the deflecting element,
wherein between the supporting surface and the wall, an opening is provided so as to relieve deformation of the wall toward the supporting surface.

2. An apparatus according to claim 1, wherein the opening is provided between the deflecting element and said wall so as to extend along said wall.

3. An apparatus according to claim 1, wherein said optical system casing is provided with an opening for permitting passing of laser light used for deflection scanning by said deflecting device through the opening.

4. An apparatus according to claim 1, wherein said optical system casing is provided with a plurality of openings extending along said wall.

5. An apparatus according to claim 1, wherein the opening is provided with a dustproof member.

6. An optical scanning apparatus comprising:
a light source for emitting light;
a deflecting device including a deflecting element for deflection-scanning a surface to be scanned with the light emitted from said light source and including a motor for driving said deflecting element; and
an optical system casing including a supporting surface for disposing thereon said deflecting device and including a wall provided to stand on the supporting surface and to face the deflecting element,
wherein the wall is provided with a first opening for emitting the light used for deflection scanning by said deflecting device and a second opening, disposed between the supporting surface and said wall, for relieving thermal deformation of said wall when the wall is thermally deformed.

7. An optical scanning apparatus comprising:
a light source for emitting light;
a deflecting device including a deflecting element for deflection-scanning a surface to be scanned with the light emitted from said light source and including a motor for driving said deflecting element; and
an optical system casing which includes a supporting surface for disposing thereon said light source and said deflecting device and which is divided by the supporting surface into a first chamber in which at least said deflection device is accommodated and a second chamber which is enclosed so as to be separated from an outside of said optical scanning apparatus,
wherein the supporting surface is provided with an opening capable of establishing communication of air between the first chamber and the second chamber.

8. An apparatus according to claim 7, wherein the second chamber is separated from the outside of said optical scanning apparatus by a shielding member which is provided to a bottom of said optical system casing and is formed of a metal material.

9. An apparatus according to claim 7, wherein said optical system casing includes a wall provided to stand on the supporting surface and to face said deflecting element and is provided with an opening, extending along the wall, between the supporting surface and the wall.

10. An apparatus according to claim 7, wherein the opening is provided between the deflecting element and said wall.

11. An apparatus according to claim 7, wherein said optical system casing is provided with an opening for permitting passing of laser light used for deflection scanning by said deflecting device through the opening.

12. An apparatus according to claim 7, wherein said optical system casing is provided with a plurality of openings provided to the supporting surface and extending along said wall.

13. An apparatus according to claim 7, wherein the opening is provided with a dustproof member.

14. An optical scanning apparatus comprising:
a light source for emitting light;
a deflecting device including a deflecting element for deflection-scanning a surface to be scanned with the light emitted from said light source and including a motor for driving said deflecting element; and
an optical system casing including a supporting surface for disposing thereon said deflecting device and including a wall provided to stand on the supporting surface and to face the deflecting element,
wherein the supporting surface and the wall are separated from each other so as to relieve deformation of the wall toward the supporting surface.

15. An apparatus according to claim 14, wherein said optical system casing is provided with an opening for permitting passing of laser light used for deflection scanning by said deflecting device through the opening.

16. An apparatus according to claim 14, wherein the supporting surface and the wall are separated from each other at a plurality of portions.

17. An apparatus according to claim 16, wherein the plurality of portions extends along the wall.
